(19) United States
(12) Patent Application Publication
(10) Pub. No.: US 2006/0162620 A1
(43) Pub. Date: Jul. 27, 2006

(54) Encapsulated photoluminescent particulates and aggregates made therefrom

(75) Inventors: Fred Horton JR., Pt. St. John, FL (US); Robert Howard Kari, Ocoee, FL (US)

Correspondence Address: AKERMAN SENTERFITT, P.O. BOX 3188, WEST PALM BEACH, FL, 33402-3188, US

(73) Assignee: C.L. Industries, Inc., Orlando, FL (US)

(21) Appl. No.: 11/042,679

(22) Filed: Jan. 25, 2005

(51) Int. Cl. C09K 11/02; C04B 16/00

(52) U.S. Cl. 106/712; 252/301.36; 428/407

(57) ABSTRACT

An encapsulated photoluminescent particle. The photoluminescent particle may be used in the formation of aggregates. The aggregates may be used in the formation of various substrates, especially for aqueous environments, such as swimming pools, aquariums, spas and fish ponds. In general, the photoluminescent particles include a resin, a photoluminescent compound, and a catalyst. The composition may be granulated to form the photoluminescent particle. The photoluminescent particles may be formed without the need of additional filler materials.

### FIELD OF THE INVENTION

The present invention relates generally to photoluminescent materials and more specifically to encapsulated photoluminescent particles and uses thereof.

### BACKGROUND OF THE INVENTION

Aqueous environments such as pools, spas, aquariums, ponds and the like generally comprise lights to illuminate the aqueous environment. These lights can be submerged in the environment, directed at the environment, or simply ambient in nature. In addition, the lights can comprise numerous colors and shades to provide the desired effect to the aqueous environment. A significant drawback to the use of electric lighting is the cost associated therewith.

One alternative to electric lighting is the use of photoluminescents. Photoluminescents create artificial light without consuming electricity or generating heat. Photoluminescents absorb electromagnetic radiation (ER), generally light, store it and emit it over time after the ER source has been removed. For example, a light source, such as the sun, can charge a photoluminescent by exciting the underlying luminescent pigment with a particular ER wavelength. Once the luminescent pigment is charged and the light ER source removed, the photoluminescent slowly emits the charged light and creates a glow in the dark effect.

Prior attempts have been made to create aqueous environments using photoluminescents. These environments generally comprise photoluminescent pigments being added directly into the substrate which they are intended to illuminate.

For example, U. S. Pat. No. 6,818,153 to Burnell-Jones discloses the addition of photoluminescent pigment into the gel coat layer of a fiber glass article, such as a pool to create a photoluminescent substrate. Fillers are added to reinforce the gel coat and provide the underlying fiberglass with the requisite strength to retain its shape and contents. These gel coats are not particles and use fillers that hinder the formation of particles from the gel coats.

The 6,596,074 patent to Pomeroy discloses the addition of a luminescence compound to an aggregate such as concrete or mortar. The patent teaches the addition of a photoluminescent pigment directly into an aggregate mixture. In application, such a mixture is not effective as the photoluminescent compound is significantly diluted among the aggregate and its photoluminescent qualities are severely diminished. Accordingly, there is little or no photoluminescent effect in the underlying aggregate.

The documents and publications cited in this disclosure are incorporated by reference in their entirety, to the extent they are not inconsistent with the explicit teachings set forth herein.

It would be beneficial to provide a photoluminescent particle that may be capable of being effectively used in an underwater environment. It would also be beneficial to provide a photoluminescent particle that may be encapsulated in particulate form without the need for excess materials. It would also be beneficial to provide a photoluminescent particle that may be admixed with other materials and used in the formation of various substrates.

### SUMMARY OF THE INVENTION

The present invention relates to an encapsulated photoluminescent particle and systems and methods of using this particle. The photoluminescent particle may be used in the formation of aggregates that may be used in the formation of various substrates, including, but not limited to, aqueous environments, such as swimming pools, aquariums, spas, fish ponds and the like. In one embodiment, the photoluminescent particles include a resin, a photoluminescent compound, and a catalyst. The composition may be granulated to form a photoluminescent particle having a particle size less than about 5 mm. The photoluminescent particles may be formed without the need of additional filler materials.

Aspects of the present invention include an encapsulated photoluminescent particle having a resin, a photoluminescent compound, and a catalyst, wherein the encapsulated photoluminescent particle is less than about 5 mm in size.

The encapsulated photoluminescent particle may also include a U/V stabilizer to prevent premature degradation of the particle as a result of exposure to a U/V source.

Aspects of the present invention may also include an aggregate having encapsulated photoluminescent particles, wherein the particles comprise a resin, a photoluminescent compound, and a catalyst. The aggregate may include cement and at least one other material, such as, for example, lime, sand, marble, rock, clay, kaolin, silica, calcium, magnesium, polyester, polyethylene, or any combination thereof. When added to an aggregate, the photoluminescent particles are designed to provide photoluminescent qualities in the aggregate and/or any substrate formed by the aggregate.

The aggregate may be used to create a substrate for an aqueous environment, including, but not limited to, a pool, a spa, an aquarium, or a pond.

Aspects of the present invention also contemplate a method of manufacturing encapsulated photoluminescent particles. The method includes admixing a photoluminescent compound with a resin to create a mixture, admixing a catalyst to the mixture wherein the catalyst chemically reacts with the mixture to create a substantially solid composition. The substantially solid composition may be mechanically or otherwise granulated to produce encapsulated photoluminescent particles.

In an alternative embodiment, during formation of the photoluminescent particles, a substantially homogeneous resin/luminescent mixture is formed prior to the addition of the catalyst.

The encapsulated photoluminescent particles may be sized to yield particles of substantially similar size. In one embodiment, for example, the particles may be sized by passing the particles through a series of sizing screens.

Aspects of the invention may also include a method of manufacturing a photoluminescent aggregate. The method includes obtaining an aggregate, obtaining an encapsulated photoluminescent particle comprising a resin, a photoluminescent compound and a catalyst, wherein the encapsulated photoluminescent particle is admixed into the aggregate at a concentration sufficient to impart a photoluminescent characteristic in the aggregate. A concentration of at least about 0.5% of the photoluminescent aggregate mixture by weight is generally sufficient to impart photoluminescent characteristics to the aggregate.

The aggregate may include cement and other materials, such as lime, sand, marble, rock, clay, kaolin, silica, calcium, magnesium, polyester, polyethylene, or any combination thereof.

Aspects of the present invention contemplate methods of using the photoluminescent aggregate. Methods include obtaining an aggregate having encapsulated photoluminescent particles, wherein the particles include a resin, a photoluminescent compound, and a catalyst, and using the aggregate for forming a substrate.

The substrate may be used in a variety of different embodiments including, but not limited to, an aqueous environment, such as for example, a pool, a spa, an aquarium, or a pond.

Further objects and advantages of the present invention will become apparent by reference to the following detailed description of the preferred embodiment.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

Aspects of the present invention contemplate an encapsulated photoluminescent particle for addition to substrate material. The encapsulated photoluminescent particle, in one embodiment, includes a resin, a photoluminescent compound, and a catalyst. By way of example, the photoluminescent compound, such as Lumilux® and the like, may be admixed with a resin, such as, for example, polyester, to create a mixture. In alternative embodiments, the mixture may be a substantially homogenous mixture. A catalyst, such as, for example, vinylbenzene (styrene), is then admixed with the photoluminescent/resin mixture wherein the mixture hardens under chemical reaction. After the composition is sufficiently hardened it is ground and passed through one or more sizing screens to yield encapsulated particles of substantially similar size.

When the selected size particles are isolated, they may then be admixed with an aggregate material such as, for example, cement, mortar or grout wherein the encapsulated particles become an integral portion of the aggregate. The photoluminescent containing aggregate may be used to form a substrate. Due to the fact that the photoluminescent pigments are encapsulated within a resin, the photoluminescent particles are especially useful in aqueous environments including, but not limited to, pools, spas, aquariums or ponds.

It is important to note that encapsulating the photoluminescent compound in the catalyst admixture is beneficial to obtaining the effect of the photoluminescent compound in aggregates such as concrete, mortar or grout. Encapsulation prior to introduction into an aggregate prevents the dilution of the photoluminescent compound and permits each particle having exposure to an ultraviolet light source to glow independently. In manufacturing the encapsulated photoluminescent particles, fillers are not needed due to the filler's tendency to dilute the photoluminescent characteristic of the particle as well as potentially interfere with the formation of smaller particles.

Once charged, generally by the application of a light source, the photoluminescent particles will luminesce when the light source is removed thereby causing the substrate to glow in the dark. Particles of different size may be used in various mixture concentrations to provide a wide variety of photoluminescent effects. For example, higher concentrations of fine particulates may be used to create a uniform full glow effect in the substrate, whereas reducing the concentration of the particles and increasing the size of the particles may be used to create a more starry effect in the substrate.

Photoluminescents are compounds that emit light without causing heat. Photoluminescent substances are known, and include sulfides, metal aluminate oxides, silicates and various rare earth compounds, such as, rare earth oxides. One common photoluminescent pigment is a zinc sulfide. Another common photoluminescent is a calcium aluminate. These photoluminescents may include, in various alternative embodiments, various activators, coactivators and compensators such as, copper, aluminum, silver, gold, magnesium, manganese, gallium, indium, scandium, lead, barium, strontium, cerium, terbium, europium, gadolinium, samarium, praseodymium or other rare earth elements and halogens. The addition of various activators and other compounds may be used to create photoluminescent pigments in a variety of colors. A commercial example of photoluminescent pigments sold in varying colors are those available under the Lumilux® brand of pigments. The Lumilux® pigments are particularly well suited for the present invention.

Resins are classes of solid, semi-solid or liquid organic products of natural or synthetic origin, generally of high molecular weight with no definite melting point. When catalyzed, the resin cures by undergoing a polymerization process, transforming the resin into a solid. Resins may be used to surround and hold fibers or used to form solid compositions. A cured resin often creates a composite material with mechanical properties that exceed those of the individual components. Most uncured resins used in open molding are liquids. Resins are often used as the binder in coatings and may be translucent or transparent. Examples of resins useful in the present invention include, but are not limited to, acrylics, alkyds, copal esters, epoxies, polyurethanes, polyesters, polyvinyl chlorides, silicones, vinyls, vinyl esters, or any other resin capable of encapsulating a photoluminescent pigment. Aspects of the present invention include the addition of a photoluminescent compound, such as, Lumilux® to a resin. The mixtures may, in select embodiments, be substantially homogenous mixtures.

Catalysts, also known as resin activators or hardeners, are substances that increase the rate of a chemical reactions without being consumed in the reactions. Catalysts may be used to lower the activation energy for a chemical reaction by providing an alternate pathway for the reaction. Often catalysts are added to polymers, organic resins or synthetic resins to promote polymerization and curing. Examples of catalysts that may be used in the present invention include, but are not limited to, vinylbenzene, di-vinylbenzene or any other catalyst or resin activator capable of polymerizing a photoluminescent/resin mixture to create a substantially solid composition.

In alternative embodiments, an ultraviolet stabilizer may be added to the resin/photoluminescent mixture prior to catalyzation to maintain the integrity of the mixture when exposed to UV light and prevent premature degradation caused by exposure. Alkaline earth metal type aluminate phosphors may be used as U/V stabilizers to prevent the photoluminescent particles from premature degradation. The metal aluminate phosphors, such as activated alkaline earth aluminate oxides, exhibit U/V insensitivity and may result in a bright and extended luminescence. In those embodiments wherein a U/V stabilizers is used, the stabilizer is generally added to the photoluminescent/resin mixture prior to the catalyzation of the mixture. In alternative embodiments, more than one U/V stabilizer may be used.

Once catalyzation occurs, the resulting composition is substantially solid. This substantially solid composition may then be broken or ground by mechanical or other means into particles. The resulting particles may be sized by known methods, such as, for example, passing the particles through a series of sizing screens to isolate particles of substantially similar size. Once the particles have been sized, they may be admixed into an aggregate. It should be noted, however, that in some embodiments, the particles may be admixed with the aggregate without sizing them, depending on the selected characteristics of the final aggregate.

Aggregates, according to aspects of the present invention include substances, such as, for example, concrete, mortar, grout and the like. Aggregates generally include cement in addition to additives, such as lime, sand, marble, rock, clay, kaolin, silica, calcium, magnesium, polyester, polyethylene, as well as commercial additives, such as, Marble XO, Marble CP Filler, Optiwhite, Hi-Fibe 254, NYAD-G, RP 226, RP 245, Colored Aggregate Blue, Metastar, Easyspred, Super Air Plus, Clay Thickener 40, or any combination thereof. The encapsulated photoluminescent particles are added to the aggregate mixture prior to setting the mixture as a substrate. Because of the encapsulated nature of the photoluminescent particles, there is no need to specially treat the aggregate mixture prior to the addition of the particles.

It is to be understood that while the invention has been described in conjunction with the specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

### EXAMPLES

### Example 1

Photoluminescent Composition

| | | |
|---|---|---|
| 19 | oz. | polyester casting resin |
| 2.85 | oz. | Lumilux ® photoluminescent pigment |
| 0.5 | oz. | vinylbenzene (styrene) catalyst |

Example 1 represents a formulation of the underlying encapsulated photoluminescent composition prior to granulation according to aspects of the present invention.

### Example 2

| | |
|---|---|
| 2500 lbs | white cement |
| 5325 lbs | Marble XO |
| 650 lbs | Marble CP Filler |
| 100 lbs | encapsulated photoluminescent particles |
| 400 lbs | lime |
| 10 lbs | Optiwhite |
| 15 lbs | HiFibe 254 |

Example 2 represents an aggregate mixture that may be used for creating a substrate according to aspects of the present invention.

### Example 3

| | |
|---|---|
| 4370 lbs | 295 Blend Sand |
| 2900 lbs | white cement |
| 100 lbs | encapsulated luminescent particles |
| 550 lbs | colored aggregate blue |
| 25 lbs | NYAD G |
| 20 lbs | Hi-Fibe 254 |
| 10 lbs | RP 245 |

Example 3 represents an alternate embodiment of an aggregate mixture that may be used for creating a substrate according to aspects of the present invention.

### Example 4

| | |
|---|---|
| 4330 lbs | 295 Blend Sand |
| 2975 lbs | white cement |
| 100 lbs | encapsulated luminescent particles |
| 550 lbs | colored aggregate blue |
| 25 lbs | NYAD G |
| 20 lbs | Hi-Fibe 254 |

Example 4 represents an additional alternate embodiment of an aggregate mixture that may be used for creating a substrate according to aspects of the present invention.

### Example 5

| | |
|---|---|
| 3100 lbs | white cement |
| 100 lbs | encapsulated luminescent particles |
| 4700 lbs | rock 8/16 |
| 50 lbs | Metastar |
| 50 lbs | Hi-Fibe 254 |

Example 5 represents another alternate embodiment of an aggregate mixture that may be used for creating a substrate according to aspects of the present invention.

### Example 6

| | | |
|---|---|---|
| 6245 | lbs | white cement |
| 100 | lbs | encapsulated luminescent particles |
| 4900 | lbs | rock 6/10 |
| 26 | lbs | easy spread |
| 20.75 | lbs | Hi-Fibe 254 |
| 0.12 | lbs | Super Air Plus |

Example 6 represents an additional alternate embodiment of an aggregate mixture that may be used for creating a substrate according to aspects of the present invention.

### Example 7

Ceramic grout

| | | |
|---|---|---|
| 1127.984 | lbs | white cement |
| 1238.029 | lbs | sand |
| 30 | lbs | encapsulated luminescent particles |
| 15.001 | lbs | clay thickener |
| 2.249 | lbs | RP226 |
| 7.483 | lbs | calcium formate |

Example 7 represents an alternate embodiment of an aggregate mixture comprising ceramic grout that may be used for creating a substrate according to aspects of the present invention.

The preceding disclosure presents the best mode devised by the inventor for practicing the invention and is intended to enable one skilled in the pertinent art to carry it out, it is apparent that methods incorporating modifications and variations will be obvious to those skilled in the art. As such, it should not be construed to be limited thereby but should include such aforementioned obvious variations and be limited only by the spirit and scope of the following claims.

What is claimed is:

1. An encapsulated photoluminescent particle comprising:
a resin;
a photoluminescent compound; and
a catalyst,
wherein said encapsulated photoluminescent particles are less than about 5 mm in size.

2. The encapsulated photoluminescent particle of claim 1 wherein said particle further comprises a U/V stabilizer.

3. An aggregate comprising encapsulated photoluminescent particles, wherein said particles comprise a resin; a photoluminescent compound; and a catalyst.

4. The aggregate of claim 3 wherein said aggregate comprises cement and at least one other material selected from: lime, sand, marble, rock, clay, kaolin, silica, calcium, magnesium, polyester, polyethylene, or a combination thereof.

5. The aggregate of claim 4 wherein said aggregate is capable of providing photoluminescent qualities in a substrate.

6. The aggregate of claim 5 wherein said substrate is located in an aqueous environment.

7. The aggregate of claim 6 wherein said aqueous environment is selected from: a pool; a spa; an aquarium; and a pond.

8. The aggregate of claim 3 wherein said encapsulated photoluminescent particle further comprises a U/V stabilizer.

9. A method of manufacturing encapsulated photoluminescent particles comprising:
admixing a photoluminescent compound with a resin to create a mixture;
admixing a catalyst to said mixture wherein said catalyst chemically reacts with said mixture to create a substantially solid composition; and
granulating said substantially solid composition to produce encapsulated photoluminescent particles having a size less than about 5 mm.

10. The method of claim 9 wherein said mixture is a substantially homogenous mixture.

11. The method of claim 9 wherein a U/V stabilizer is added to the mixture prior to the admixing of said catalyst.

12. The method of claim 9 wherein said particles are sized to yield particles of substantially similar size.

13. The method of claim 12 wherein said particles are sized by passing said particles through a series of sizing screens.

14. A method of manufacturing a photoluminescent aggregate comprising:
obtaining an aggregate; and
obtaining an encapsulated photoluminescent particle comprising a resin, a photoluminescent compound and a catalyst,
wherein said encapsulated photoluminescent particle is admixed into said aggregate at a concentration sufficient to impart a photoluminescent characteristic in said aggregate.

15. The method of claim 14 wherein said aggregate imparts a photoluminescent characteristic in a substrate.

16. The method of claim 14 wherein said encapsulated photoluminescent particle further comprises a U/V stabilizer.

17. The method of claim 14 wherein the amount of said photoluminescent particle is at least 0.5% of the photoluminescent aggregate mixture by weight.

18. The method of claim 14 wherein said substrate is located in an aqueous environment.

19. The method of claim 18 wherein said aqueous environment is selected from: a pool; a spa; an aquarium; and a pond.

20. The method of claim 14 wherein said aggregate is comprised of cement and at least one other material selected from: lime; sand; marble; rock; clay; kaolin; silica; calcium; magnesium; polyester; polyethylene; or any combination thereof.

21. A method of using a photoluminescent aggregate comprising:
obtaining an aggregate having encapsulated photoluminescent particles and wherein said particles comprise a resin, a photoluminescent compound, and a catalyst; and
forming a substrate using said aggregate.

22. The method of claim 21 wherein said encapsulated photoluminescent particles further comprise a U/V stabilizer.

23. The method of claim 21 wherein the amount of said photoluminescent particle is at least 0.5% of the photoluminescent aggregate mixture by weight.

24. The method of claim 21 wherein said substrate is located in an aqueous environment.

25. The method of claim 24 wherein said aqueous environment is selected from the group consisting of: a pool; a spa; an aquarium; and a pond.

26. The method of claim 21 wherein said aggregate is comprised of cement and at least one other material selected from the group consisting of: lime; sand; marble; rock; clay; kaolin; silica; calcium; magnesium; polyester; polyethylene, or any combination thereof.
